(19) United States
(12) Patent Application Publication
(10) Pub. No.: US 2006/0200738 A1
(43) Pub. Date: Sep. 7, 2006

(54) System and method for modifying a mobile device application

(75) Inventors: Martin A. Tarle, Toronto (CA); Justin P. Simonelis, Toronto (CA)

Correspondence Address: BERESKIN AND PARR, 40 KING STREET WEST, BOX 401, TORONTO, ON, M5H 3Y2, CA

(73) Assignee: Tira Wireless Inc., Toronto (CA)

(21) Appl. No.: 11/364,205

(22) Filed: Mar. 1, 2006

Related U.S. Application Data
(60) Provisional application No. 60/657,435, filed on Mar. 2, 2005.

(51) Int. Cl. G06F 17/00

(52) U.S. Cl. 715/500

(57) ABSTRACT

A system and method of porting a reference application to a target mobile device are disclosed. The method includes: a) injecting a first instruction set into the reference application, where the first instruction set instantiates a MIDlet proxy object for a MIDlet object in the reference application; b) injecting a second instruction set into the reference application, where the second instruction set instantiates a Canvas proxy object for a Canvas object in the reference application; b) executing the reference application modified with the first and second instruction sets. The executing step includes: (i) storing a number of events on a data structure, where the events relate to the MIDlet and Canvas objects; (ii) generating an execution thread for sequentially executing the events stored in the data structure; and (iii) executing the execution thread.

### CROSS-REFERENCE TO RELATED APPLICATIONS

This application claims priority to U.S. Provisional Application No. 60/657,435 filed on Mar. 2, 2005, which is incorporated by reference herein in its entirety.

### FIELD OF THE INVENTION

The invention relates to software application development for mobile devices. In particular, the invention relates to porting applications from one mobile device to another mobile device.

### BACKGROUND OF THE INVENTION

The popularity of mobile devices, such as wireless phones, pagers, and personal digital assistants (PDAs) continues to increase. As more and more people acquire mobile devices, the number of different types of devices available have also increased, as well as the capabilities of such devices. Many of these mobile devices are customized using software applications which run on these devices. Examples of application programs available on mobile devices include games, mail programs, and contact management applications.

Application programs are written for a particular mobile device which may have unique characteristics, such as processing power, display size and characteristics, architecture, and operating system. Consequently, applications written for a particular mobile device may not execute optimally or at all on a different mobile device.

The process of taking an application which has been programmed to run on one mobile device (referred to as a “reference mobile device”) and optimizing for another mobile device (referred to as a “target mobile device”) is referred to as “porting”.

One particular problem is encountered in porting Java 2 Platform, Micro Edition (J2ME) applications. The two main object classes used to create various J2ME applications, such as games, are the MIDlet class and the Canvas class. The MIDlet class represents an application, and may implement the startApp, pauseApp, and destroyApp events, which are called by the Java Virtual Machine (JVM) at various times during the lifecycle of the application. The Canvas class represents a displayable object, which may implement hideNotify, showNotify, keypressed, keyReleased, keyRepeated, and paint events.

Various mobile devices may handle the above system events differently. These differences may create problems in porting the applications. For example, many devices allow a limited time for JVM events to execute. If the allotted time is exceeded, the event implementation may be ignored, the application may be shut down, or the event thread may be terminated. These outcomes typically cause the application to behave incorrectly, crash, or freeze. Some specific examples with reference to particular mobile devices are set out below.

On the Samsung™ S300 mobile phone, if an application is executing too much code on the system event thread, some keyPressed events may be ignored. This can be very frustrating to the user, as the application will just not respond to some key presses.

On the Sharp™ GX10 mobile phone, when there is an incoming call, the JVM calls pauseApp and hideNotify to notify the application that the application management system wants it to pause. The Sharp™ GX10 allows a limited amount of time for these events to execute, after which it shuts down the application with a “Discontinued” message. If an application waits too long or executes too much code in these events, it will not run correctly on this device.

On the Siemens S65™ mobile phone, the serviceRepaints JVM call is used to force the JVM to call the paint event to repaint the screen. If the system thread is too busy executing other events when serviceRepaints is called, the JVM will terminate it. This freezes the application, as no more events can be executed.

Another common problem is that some operations do not work if they are executed from the context of the JVM event thread. In particular, operations that generate additional events are the most likely to be ignored by the JVM when they are executed in this context.

For example, on the Motorola T720™ mobile phone, the setCurrent JVM call is used to change the currently displayed Canvas object. If setCurrent is called on a Motorola T720™ from within the context of hideNotify or showNotify events, the setCurrent method will fail to execute. If an application is calling the setCurrent method in these events, to display a paused screen for example, it will not run correctly on this device.

One solution to the above problems is to execute the code in the above methods in a separate thread. Unfortunately, moving the code from the events to another thread is a time consuming manual process. The code must be refactored manually, and care must be taken to properly synchronize it with the rest of the application.

Accordingly, there is a need for systems and methods for automating the porting of an application configured for a reference mobile device to one or more target mobile devices.

### SUMMARY OF THE INVENTION

According to a first aspect of the invention, a method of porting a reference application to a target mobile device is provided. The method comprises:
a) injecting a first instruction set into the reference application, wherein the first instruction set instantiates a proxy for a first object in the reference application;
b) executing the reference application modified with the first instruction set, wherein the executing step comprises:
   (i) storing a plurality of events in a data structure, wherein at least one of the plurality of events relate to the first object;
   (ii) generating an execution thread for sequentially executing the plurality of events stored on the data structure; and
   (iii) executing the execution thread.

Preferably, the method also includes injecting a second instruction set into the reference application, wherein the second instruction set instantiates a proxy for a second object in the reference application. Preferably, the first object is a MIDlet object and the proxy for the first object is a MIDlet Proxy object. Preferabaly, the second object is a Canvas object and the proxy for the second object is a Canvas Proxy object.

According to a second aspect of the invention, a system for porting a reference application to a target mobile device is provided the system comprises:
a) a first instruction set adapted to instantiate a proxy for a first object in the reference application;
b) an executable software module adapted to inject the first instruction set into the reference application; and
c) a data structure;
wherein the proxy for the first object is adapted to store a plurality of events in the data structure.

Preferably, the system includes a second instruction set which instantiates a proxy for a second object in the reference application. Preferably, the first object is a MIDlet object and the proxy for the first object is a MIDlet Proxy object. Preferably, the second object is a Canvas object and the proxy for the second object is a Canvas Proxy object.

### BRIEF DESCRIPTION OF THE DRAWINGS

In the accompanying figures:

FIG. 1 is a block diagram of an executable module and a reference application.

FIG. 2 is a block diagram showing a JVM and the elements of the reference application modified according to a preferred embodiment of the present invention.

FIG. 3 is a flow diagram of a method of porting a reference application according to a preferred embodiment of the present invention.

FIG. 4 is a flow diagram of the Execute Application step of FIG. 3.

### DETAILED DESCRIPTION OF THE PREFERRED EMBODIMENT OF THE INVENTION

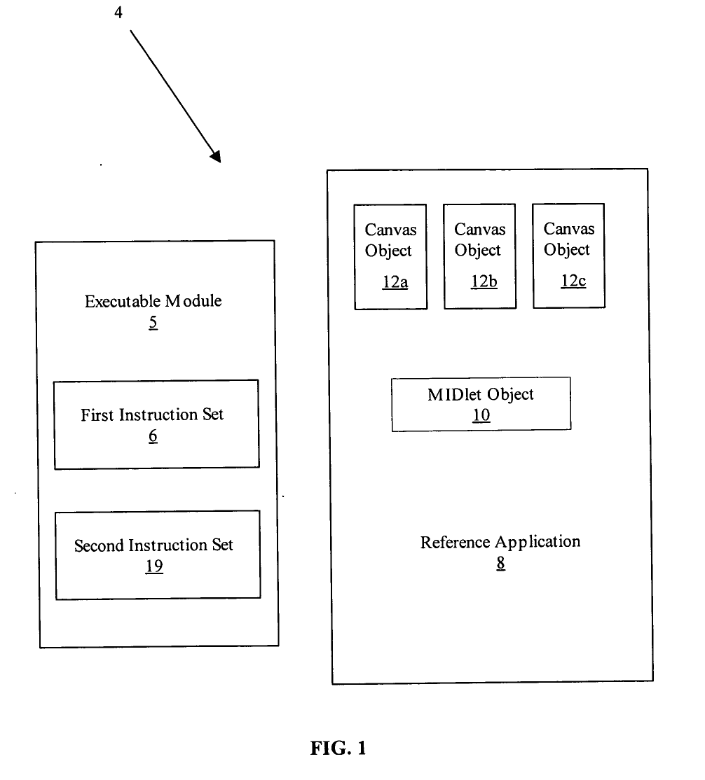

Referring to FIG. 1, a reference application 8, such as for example a video game, may be any suitable application which is developed for a reference mobile device (not shown). Preferably, the reference application 8 is a J2ME (Java 2 Platform Micro Edition) application.

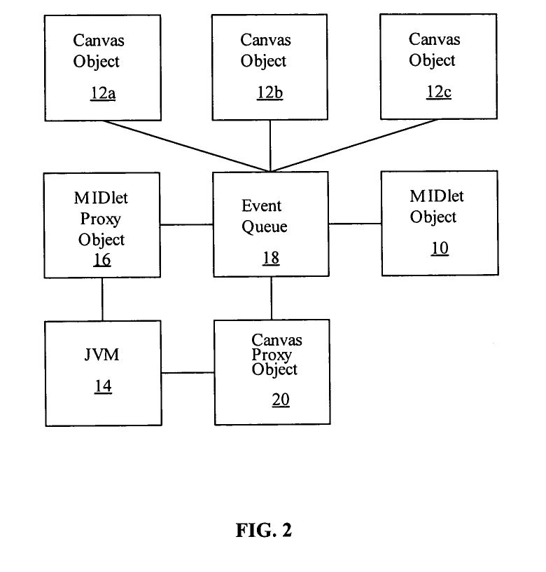

Referring to FIGS. 1 and 2, a system 4 according to a preferred embodiment of the present invention includes an executable module 5 (described below) for modifying the reference application 8. The reference application 8 includes a MiDlet object 10 and one or more Canvas objects. As an example, three such Canvas objects are illustrated in FIG. 1 as Canvas objects 12a, 12b, 12c may be included in the reference application 8. It will be understood by those skilled in the art that any suitable number of Canvas objects may be provided. The MIDlet object 10 and Canvas objects 12a-c are instances of the MIDlet and Canvas classes, respectively. The MIDlet class and Canvas class are two main classes of a J2ME reference application. The MIDlet class represents an application, and may implement the startApp, pauseApp, and destroyApp events, which are called by a JVM 14 at various times during the life-cycle of the application. The Canvas class represents a displayable object, which may implement events, such as, for example, hideNotify, showNotify, keypressed, keyReleased, keyRepeated, and paint events.

The executable module 5 may be a J2SE (Java 2 Platform Standard Edition) application or Windows™ application running on a desktop or server environment. The executable module 5 injects a first instruction set 6 into the reference application 8. The first instruction set 6 preferably consists of computer program code, such as Java™ code, which is injected into the reference application 8 to instantiate a MIDlet Proxy object 16. Specifically, the first instruction set 6 instantiates the MIDlet Proxy object 16 by renaming the MIDlet class of the reference application 8 and replacing it with the MIDlet Proxy class. The MIDlet Proxy object 16 acts as a mediator between the JVM 14 and the MIDlet object 10 of the reference application by forwarding all of the MiDlet events from the JVM 14 to a data structure. The data structure is referred to herein as an event queue 18. The event queue is preferably implemented as an array of event descriptors. The event descriptors are implemented as objects that are created only once and reused for the duration of the execution of the application.

As used herein, an “event” is preferably a call to a method. Accordingly, a MIDlet event is a method call from the JVM 14 to a method of the MIDlet object 10.

Another example of the executable module 5 is described in Applicants' co-pending U.S. patent application Ser. No. 10/975,346, filed on Oct. 29, 2004, which is incorporated by reference herein.

The executable module 5 may inject a second instruction set 19 into the reference application 8. The second instruction set 19 also preferably consists of program code. The second instruction set 19 preferably instantiates a Canvas Proxy object 20. The Canvas Proxy object 20 overrides the setCurrent JVM call to make itself the current Canvas class for the entire application. The Canvas Proxy object 20 preferably tracks all of the Canvas objects 12a-c from the reference application 8 that would be displayed. on a display screen of the mobile device. The Canvas Proxy object 20 acts as a mediator between the JVM 14 and the Canvas objects 12a-c to be displayed by forwarding all the Canvas events from the JVM 14 to the event queue 18.

It will be understood by those skilled in the art that the MIDlet Proxy object 16 and Canvas Proxy Object 20 may be instantiated by a single instruction set (such as first instruction set 6) or by more than two instruction sets.

As used herein, “injected” means not only the addition of code into a computer program or portions thereof, but may also include any other type of modification of the computer program, such as the replacement or deletion of code.

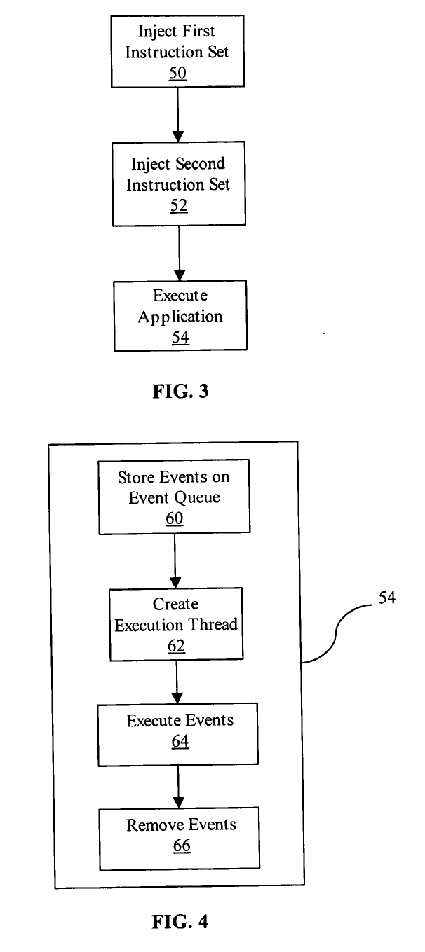

The method of porting the reference application 8 according to a preferred embodiment of the present invention will now be described with reference to FIGS. 1-3.

The method begins at step 50, where the first instruction set 6 is injected into the reference application 8 to instantiate the MIDlet Proxy object 16 (as described above).

At step 52, the second instruction set 19 is injected into the reference application 8 to instantiate the Canvas Proxy object 20 (as described above).

At step 54, the reference application 8 ( which has been modified as discussed for steps 50 and 52 above) is executed.

FIG. 4 shows the steps which occur during the execution step 54. At step 60, the MIDlet Proxy object 16 and Canvas Proxy object 20 store each corresponding event on the event queue 18, instead of forwarding the events directly to the MiDlet object 10 and Canvas objects 12a-c. These objects may also store information relating to the identity of the event that was called, the object the event was called on, and any parameters that were passed to the event. The information stored on the event queue 18 is sufficient to enable these events to be called later from a different thread, as described below.

At step 62, the MIDlet Proxy object 16 automatically injects computer program code, such as Java™ code, into the reference application 8 (which has been modified as discussed above) that creates a new thread (referred to as an execution thread) in the MIDlet Proxy constructor to monitor the event queue 18 and execute the events in the event queue as they are stored.

At step 64, the events are executed by the execution thread. At step 66, the executed events are removed.

Executing and removing events from the event queue 18 is preferably handled conservatively so this data structure does not need to be synchronized. This implementation minimizes the processing power required to store each event on the event queue 18, ensuring as little code as possible is executed in the JVM event thread.

The storing of events on the event queue 18 may remain unsynchronized, so the event code remains synchronized with whatever application code it was synchronized with originally. Because of this, and because the event queue 18 executes the events serially, the events are properly synchronized with the application.

The present invention provides the advantage of reducing problems during execution of the application (such as crashing or ignoring of event implementation) on the target mobile device by executing the application events on a single application event thread (i.e. the execution thread) started by the modified application, rather than the system event thread started by the JVM 14.

While the present invention as herein shown and described in detail is fully capable of attaining the above-described objects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it is to be encompassed by the present claims.

1. A method of porting a reference application to a target mobile device, the method comprising:
a) injecting a first instruction set into the reference application, wherein the first instruction set instantiates a proxy for a first object in the reference application;
b) executing the reference application modified with the first instruction set, wherein the executing step comprises:
i) storing a plurality of events in a data structure, wherein at least one of the plurality of events relate to the first object;
ii) generating an execution thread for sequentially executing the plurality of events stored on the data structure; and
iii) executing the execution thread.

2. The method of claim 1, wherein the storing step comprises serially storing the plurality of events in the data structure.

3. The method of claim 2, further comprising injecting a second instruction set into the reference application, wherein the second instruction set instantiates a proxy for a second object in the reference application.

4. The method of claim 3, wherein the first object is a MIDlet object and the proxy for the first object is a MIDlet Proxy object, wherein the second object is a Canvas object and the proxy for the second object is a Canvas Proxy object.

5. The method of claim 2, wherein the plurality of events comprises a system event and an application event, wherein the system event is configured to execute on a system event thread of the reference application, and the application event is configured to execute on an application event thread.

6. The method claim 5, wherein a JVM forwards the plurality of events to the Canvas Proxy or the MiDlet proxy.

7. The method of claim 6, wherein at least one of the Canvas Proxy object and the MIDlet Proxy object stores the plurality of events on the data structure.

8. The method of claim 1, wherein the data structure comprises an array of event descriptors.

9. A system for porting a reference application to a target mobile device, the system comprising:
a) a first instruction set adapted to instantiate a proxy for a first object in the reference application;
b) an executable software module adapted to inject the first instruction set into the reference application; and
c) a data structure;
wherein the proxy for the first object is adapted to store a plurality of events in the data structure.

10. The system of claim 9, further comprising a second instruction set adapted to instantiate a proxy for a second object in the reference application.

11. The system of claim 10, wherein the executable module is adapted to inject the second instruction set into the reference application.

12. The system of claim 11, wherein the first object is a MIDlet object and the proxy for the first object is a MIDlet Proxy object, wherein the second object is a Canvas object and the proxy for the second object is a Canvas Proxy object.

13. The system of claim 12, wherein the plurality of events comprises a system event and an application event, wherein the system event is configured to execute on a system event thread of the reference application, and the application event is configured to execute on an application event thread.

14. The system of claim 13, wherein at least one of the Canvas Proxy object and the MIDlet Proxy object stores the plurality of events on the data structure.
